(19) United States
(12) Patent Application Publication
(10) Pub. No.: US 2020/0311763 A1
(43) Pub. Date: Oct. 1, 2020

(54) PARALLEL CAMPAIGN PRIORITIZATION MODEL

(71) Applicant: Microsoft Technology Licensing, LLC, Redmond, WA (US)

(72) Inventors: Tao Yan, Redmond, WA (US); Tak-Ko Lu, Redmond, WA (US); Weidong Zhang, San Jose, CA (US); Zheng Yu, Redmond, WA (US); Zixuan Liu, Redmond, WA (US); Artem Baranov, Redmond, WA (US); Yonatan Yosef Tamler, Redmond, WA (US); Liren Sun, Redmond, WA (US)

(21) Appl. No.: 16/370,837

(22) Filed: Mar. 29, 2019

(51) Int. Cl. G06Q 30/02; G06F 16/2455; G06F 16/22

(52) U.S. Cl. CPC G06Q 30/0243; G06F 16/2237; G06F 16/24564

(57) ABSTRACT

Techniques of prioritizing campaigns based on scrubbing rules using a bitmap are provided. A plurality of user rules is stored and a first set of users is identified for each user rule. A user rule index is generated based on the first set of users. A plurality of campaigns is stored and a second set of users is identified for each campaign. A campaign index is generated based on the second set of users. For each user indicated in the campaign index, a set of zero or more user rules is identified and a set of one or more campaigns is identified. A second set of campaign rules of a campaign that is in the set of one or more campaigns is identified. A determination is made whether at least one rule in the second set of campaign rules is in the first set of zero or more user rules.

### TECHNICAL FIELD

The present disclosure relates to prioritizing electronic communications and, more particularly, to applying scrubbing rules and criteria for generating the electronic communications in parallel.

### BACKGROUND

A content delivery system may send electronic messages associated with campaigns to members of the content delivery system to promote a product or service. To preserve optimal user experience, only a few messages may be sent to members within a certain time period. To determine the highest priority campaign from among multiple campaigns, a set of scrubbing rules may be used to narrow down the target members for each campaign.

When dozens of rules are applied to hundreds of campaigns sequentially, a filtering process for each campaign may become resource-intensive and time-consuming. A sequential campaign prioritization process may also significantly impact the efficiency and capability of electronic communication. For example, processing time grows linearly as either the number of campaigns or the number of members increase linearly. Thus, a more efficient and scalable approach for prioritizing the electronic communications is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example campaign parallelization pipeline for prioritizing campaigns associated with members, in an embodiment;

FIGS. 2A, 2B, and 2C are flow diagrams that depict a process for prioritizing campaigns based on scrubbing rules, in an embodiment;

FIGS. 3A, 3B, and 3C are example block diagrams that depict an example process for identifying target members for campaigns, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A process stores multiple user rules. A user rule may be a scrubbing rule to narrow down one or more target members for a campaign. For each user rule of the multiple user rules, a first set of users is identified. The identified first set of users indicate association information between each rule and zero or more users. Based on the first set of users identified for each rule of the plurality of user rules, a user rule index is generated. The user rule index is another way of organizing the association information between the rules and users. In the user rule index, the association information may be organized based on a member ID.

The process also stores multiple campaigns. For each campaign of the multiple campaigns, a second set of users is identified. The identified second set of users indicate association information between each campaign and zero or more users. Based on the second set of users identified for each campaign of the multiple campaigns, a campaign index is generated. The campaign index is another way of organizing the association information between the campaigns and users. In the campaign index, the association information may be organized based on a member ID.

For each user of multiple users indicated in the campaign index, a set of zero or more user rules is identified. The set of zero or more user rules may be retrieved from the user rule index. Furthermore, for each user of the multiple users indicated in the campaign index, a set of one or more campaigns are identified.

The process further identifies a second set of campaign rules of a campaign that is included in the set of one or more campaigns. The campaign rules can be retrieved from a campaign-rule list. The campaign-rule list includes association information between campaigns and rules. These rules in the campaign-rule list are scrubbing rules that apply to a corresponding campaign to exclude certain members from the corresponding campaign.

Based on the second set of campaign rules and the first set of user rules, a determination is made whether at least one rule in the second set of campaign rules is also included in the first set of zero or more user rules. The process first identifies one or more campaigns associated with a particular member. For each campaign associated with the particular member, the process determines whether there is any overlapping rule in the second set of campaign rules and the first set of user rules. If there is at least one overlapping rule, then a particular campaign is excluded as a candidate campaign for the particular member.

Embodiments described herein improve the utility of electronic content delivery methods by prioritizing the campaigns parallelly using a parallel campaign prioritization model. Embodiments herein leverage a big data ecosystem and handle the growth of scrubbing rules, campaigns, and members efficiently. Embodiments herein ensure that the processing time to filter the rules remains constant even though the number of campaigns increases. Pre-calculated scrubbing rules (which may be stored as bitmaps) make the computation process more efficient and make better usage of computation resources. Also, an implementation based on SPARK Structured Query Language (SQL) with the SCALA programming language can easily integrate the implementation with other services or Application Programming Interfaces (APIs).

### System Overview

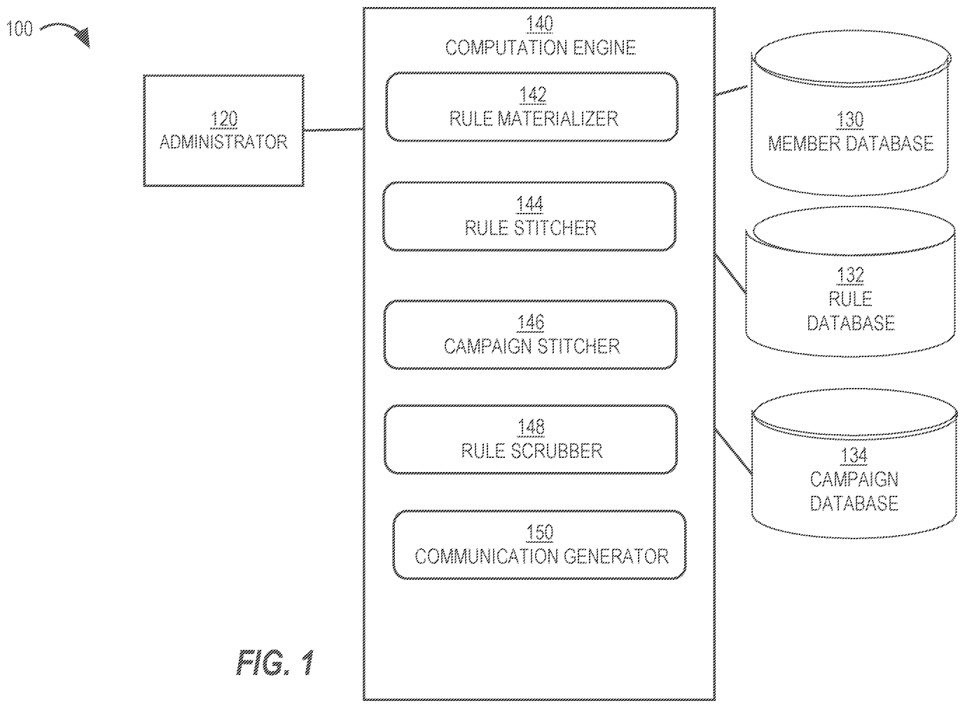

FIG. 1 is a block diagram that depicts an example campaign parallelization pipeline 100 for prioritizing campaigns associated with members, in an embodiment. A campaign parallelization pipeline 100 includes an administrator 120, a computation engine 140, a member database 130, a rule database 132, and a campaign database 134.

### Member Database

Member database 130 stores a set of member identifiers (ID) that uniquely identify respective members. Members are end-users operating client devices (not shown) that are associated with a particular online service, such as a social network service, that might be affiliated with a content delivery system (e.g., LinkedIn).

Computation engine 140 accesses member database 130 to retrieve or store the member information such as member IDs or campaign information. For example, member database 130 stores which campaigns are associated with a particular user, which campaign communication has been sent to a particular member, and/or when the campaign communication was sent.

### Rule Database

Rule database 132 stores a set of rules that may be applied to a particular user. The set of rules include a global rule and a category rule. A global rule is a rule that can be applied to all campaigns and a category rule is a rule that can be applied to all campaigns of a scrub category. An example of a global rule is one that ensures that no member is to receive four consecutive electronic communication pertaining to the same campaign, product, or service. The category rule can be determined based on a combination of the type of business units, type of channels, or type of content. An example of a category rule is one that excludes a particular member from a campaign if the particular member is associated with a certain category (e.g., age group). Category association data that associates a set of rules with a particular category may be stored in rule database 132.

Each rule may serve a different scrubbing purpose. In one example, one type of rule is related to the frequency of communication that a particular member receives less than a threshold number of email (e.g., one campaign email) per week. Another type of rule is related to a redundancy feature that the rule removes a particular member who has indicated a preference to be opted out of email communication. In one embodiment, administrator 120 can select a set of rules that will be applied to the members. In a related embodiment, rules can be determined based on the category type.

In some embodiments, the rules are pre-calculated and stored as bitmaps in rule database 132. The rules can be defined as HIVE SQLs, which are pre-calculated through SPARK SQL and stored as HDFS (Hadoop Distributed File System) files of ORC (Optimized Row Columnar) format. The rules can be converted to bitmaps using SPARK SQL with the SCALA programming language. The rules can be integrated with other Application Programming Interfaces (APIs) or services that communicate with computation engine 140.

### Campaign Database

Campaign database 134 stores a set of campaigns that is associated with a particular user. A campaign includes (or is associated with) one or more content items. A campaign is an organized way of presenting information to members that qualify for the campaign. Different content providers have different purposes in establishing a campaign. Example purposes include having members view a particular video or web page, fill out a form with personal information, purchase a product or service, make a donation to a charitable organization, volunteer time at an organization, or become aware of an enterprise or initiative, whether commercial, charitable, or political.

A campaign may specify one or more targeting criteria that are used to determine whether to present a content item of the campaign to one or more members. Example factors include date of presentation, time of day of presentation, characteristics of a member to which the content item will be presented, attributes of a computing device that will present the content item, identity of the publisher, etc. Examples of characteristics of a member include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

A particular campaign may be associated with a member if the member meets targeting criteria of the particular campaign. The campaigns may be managed by the content provider or administrator 120 and can be further modified with additional fields required by campaign communication.

In one embodiment, an administrator 120 can select a particular set of rules that is applied to the campaigns. For example, some campaigns may be associated with a particular category. Category association data that associates a set of rules with a particular category may be stored in rule database 132. The category association data may be retrieved from rule database 132. Based on the category association data, the set of rules that is associated with a particular category is determined. Administrator 120 may associate a campaign with the set of rules based on the category association data.

Campaign database 134 stores priority information of one or more campaigns. Some campaigns may be associated with higher priority values than other campaigns. If a member is associated with two more campaigns with different priority values, then a campaign with the higher priority value is selected to be used for electronic communication (e.g., a campaign email). The priority information for each campaign may be determined by administrator 120.

### Computation Engine

In one embodiment, computation engine 140 includes a rule materializer 142, a rule stitcher 144, a campaign stitcher 146, a rule scrubber 148, and a communication generator 150. Other embodiments may include more or less than these components.

Computation engine 140 may generate electronic communications, such as emails, text messages, and/or in-app messages, and send the communications to a set of selected members. In order to do so, a group of members is selected based on campaign criteria and the selected members are assigned to the campaign and rules are applied to the member assignment. This process of narrowing an audience of a campaign is referred to as “scrubbing.” Many scrubbing processes can be performed by computation engine 140 or various components within computation engine 140.

### Rule Materializer

Rule materializer 142 materializes the rules and stores the materialized rule data in rule database 132. The rule data is materialized periodically to accelerate the scrubbing and prioritization process. The input to rule materializer 142 is a rule that is defined as a SQL script. In various embodiments, each rule can be defined as a single SQL script. The output of rule materializer 142 is a list of members. If a particular rule is associated with a campaign, then any members associated with the particular rule is excluded from that campaign.

In some embodiments, the rule materialization process is performed as offline batches. The materialization of SQL rules may be performed parallelly through SPARK SQL. In various embodiments, the rule materialization process is performed regularly in that the rule data is not stale. For example, the materialized data can be refreshed daily and stored with many versions. The output of the rule materialization process can be the input of the rule stitching process.

### Rule Stitcher

Rule stitcher 144 performs a rule stitching process by building a user rule index. Optionally, the rules associated with a user are stored as a bitmap. For example, a materialized rule may be transposed to a user rule index of {key: member ID, value: rule_bitmap}. For example, an entry in the user rule index can be expressed as {member 1, bitmap 2}, indicating that member 1 is associated with rule 2.

A bit in the bitmap is set to ‘1’ if a member is associated with the materialized rule corresponding to the position of the bit in the bitmap. For example, if member A is associated with rule 2, then the second bit of the bitmap associated with member A is set to ‘1.’ Storing the rules as bitmaps allows the fast loading of rules into memory and leveraging bit operations to achieve an efficient scrubbing process. In one embodiment, a rule bitmap can be compressed with Hexadecimal encoding. For example, if there are forty rules, then a bitmap for member A can be presented as follows and stored as ‘member A:F6AA87EAAC’ in the file.

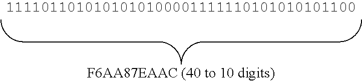

### Campaign Stitcher

Campaign data is pre-calculated and stored in campaign database 134. The campaign data may include campaign metadata and the association information between the campaigns and members. For example, one entry of the campaign data may indicate that campaign 1 is associated with member 1, member 3, and member 5. Another entry of the campaign data may indicate that campaign 2 is associated with member 2, member 3, and member 6. In this instance, member 3 is associated with both campaigns 1 and campaign 2. To better organize the association information between the campaigns and the members, a campaign index can be generated.

Campaign stitcher 146 builds a campaign index and transposes campaigns to a campaign index of {key: member ID, value: list_of_campaign_ID}. For example, based on one or more data entries for each campaign, a campaign index can be generated as {member 3: campaign 1, campaign 2}, indicating that member 3 is associated with campaign 1 and campaign 2. As shown in the example, the campaign index can be organized based on the member ID and the campaign index can be used as the input for the rule scrubbing process.

### Rule Scrubber

Rule scrubber 148 performs a rule scrubbing process by generating a map by combining the user rule index and the campaign index. An example map can be expressed as {member ID, list_of_campaign_ID, rule_bitmap}. For example, the map can be expressed as {member 1: L1, (r1, r2, r3)}, indicating that member 1 is associated with campaign 1, and rule 1, rule 2, and rule 3. A bitmap of the member-rule index is joined with a member-campaign index to be transposed to a new map that shows an association among members, rules, and campaigns.

Rule scrubber 148 identifies a set of campaign-rule lists that identifies an association between campaigns and the rules. In an embodiment, the rules are exclusionary rules in that if a target member is associated with a rule identified in the campaign-rule list for a particular campaign, then the target member is excluded from the particular campaign. In this case, a rule identified in the campaign-rule list that is also included in a map is referred to as an “overlapping” or “intersecting” rule.

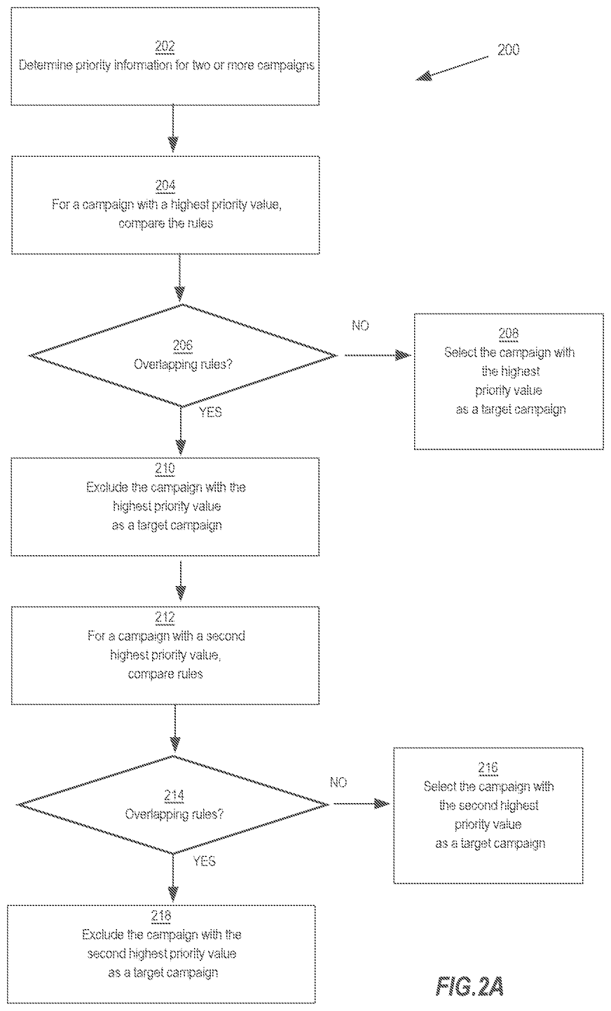

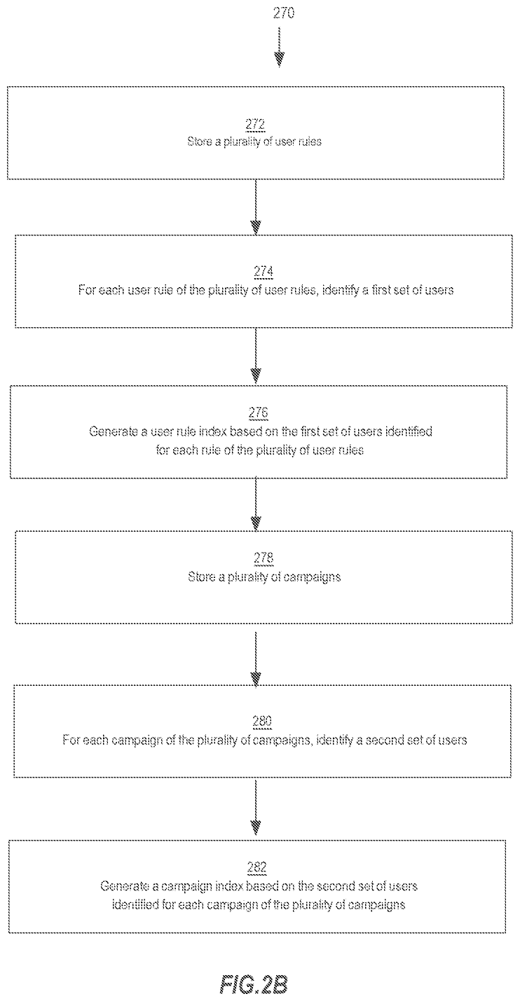

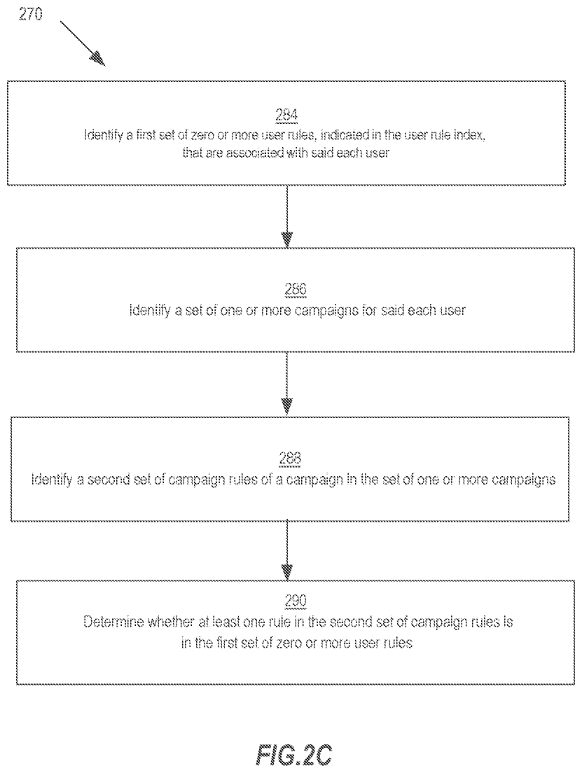

In some embodiments, rule scrubber 148 identifies priority information among the campaigns for each member that is identified in the map. A campaign with a higher priority value is determined to be processed before a campaign with a lower priority value. The priority values can be determined from campaign database 134. FIG. 2A is a flow diagram that depicts an example process 200 for prioritizing campaigns when there are more than two campaigns with different priority values.

Firstly, rule scrubber 148 determines the number of campaigns associated with each member. If there is only one campaign that is associated with a member, a rule scrubbing process is performed only on the identified campaign. If there is more than one campaign associated with the member, then rule scrubber 148 determines priority information for the identified two or more campaigns at block 202. The priority of the campaigns may be reflected in the order of the campaigns listed in the user-campaign index.

At block 204, for a campaign that has a highest priority value, rule scrubber 148 compares the rules identified in the map and the rules identified in a campaign-rule list for the campaign. At block 206, it is determined whether there is any overlapping rule. If there is no overlapping rule, rule scrubber 148 selects the campaign with the highest priority value as a target campaign at block 208.

At block 206, if there is an overlapping rule (one overlapping rule is enough), then the campaign with the highest priority value is excluded from a target campaign at block 210. After the exclusion, the rule scrubbing process continues to block 212 since there is more than one campaign that is associated with the particular member. At block 212, the rule scrubbing process identifies a campaign with a second highest priority value and compares the rules.

Similar to a comparison process performed at block 206, for a campaign that has the second highest priority value, rule scrubber 148 compares the rules identified in the map and the rules identified in the campaign-rule list for the second campaign. At block 214, if there are any overlapping rules, then the campaign with the second highest priority value is excluded as a target campaign at block 218. If there are more than two campaigns associated with the particular member, then a similar scrubbing process continues to compare rules for the next campaign with a third highest priority value. If there are no overlapping rules for the campaign with the second highest priority value, then the campaign with the second highest value is selected as a target campaign at block 216 and an electronic communication (e.g., email associated with the campaign with the second highest value) is sent to the particular member.

In various embodiments, the rules associated with a member and the rules associated with a campaign are pre-calculated and stored as bitmaps. Bitmap operations can be performed on a bitmap for the user rule index and a bitmap for the campaign-rule list. With multiple transpositions, the campaign prioritization may be processed in a parallel manner, enabling the processing of member 1 and member 2 at the same time. Members in the map are distributed to several hundred executors (many-to-one), each of which may process a set of members (e.g., a million), and generate {member ID, campaign_ID} pairs as the output. The {member ID, campaign_ID} pairs may be transposed back to be ordered based on a campaign ID.

The entire process can be executed based on a scrubbing and prioritization schedule created by administrator 120 (e.g., within a day). In some embodiments, the rule materialization and stitching processes are executed in the previous day of the scrubbing and prioritization run. Both the rule stitching process and the rule scrubbing process can be implemented as SPARK jobs.

### Communication Generator

Communication generator 150 generates emails containing the determined campaigns and sends the campaign emails to the target members. One way of generating the campaign emails is by using a cross-channel email service. Example communication generator 150 includes a File Transfer Protocol (FTP) server of an email system. The bitmap list can be transferred to the FTP server of the email system and emails can be generated from the FTP server of the email system. Even though campaign email is used as an example of electronic communication, other types of electronic communication can be initiated by communication generator 150, such as text messages or in-app messages.

### Process Overview

FIGS. 2B and 2C are flow diagrams that depict a process for prioritizing the campaigns based on scrubbing rules, in an embodiment. Process 270 may be implemented by computation engine 140.

At block 272, multiple user rules are stored in rule database 132. The rules are defined in the rule metadata by administrator 120. Each rule may be a single script that is composed and stored in rule database 132. The rules indicate specific filtering criteria such as determining which members to exclude from the campaign email. Each rule can be modified or selected based on a combination of a business unit, channel, or a campaign type.

In some embodiments, a rule materialization process is performed. The rule materialization process defines, materializes, and executes a single script of each rule and stores the result in rule database 132. The result of the rule materialization process can be a list of members and can be used as input for a rule stitching process.

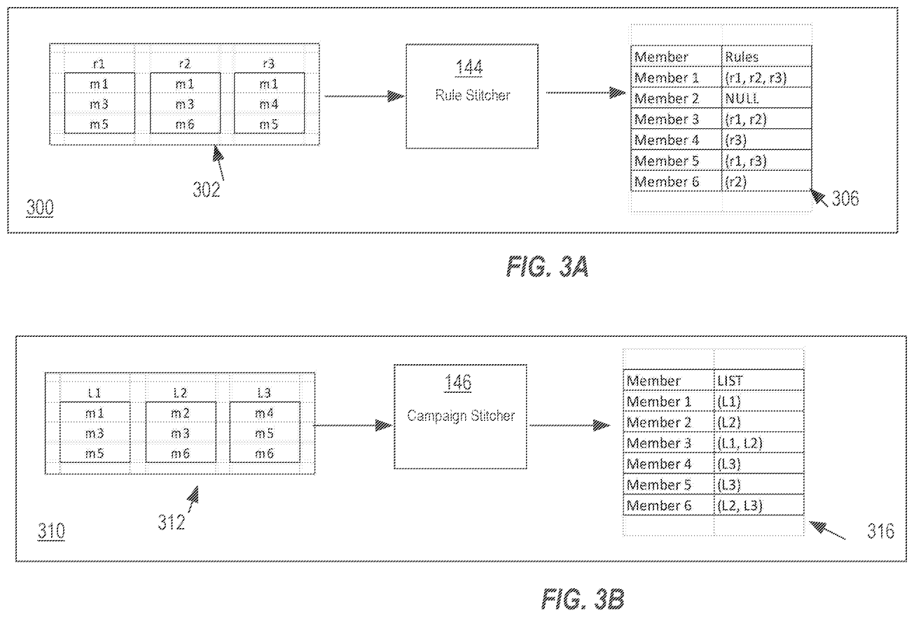

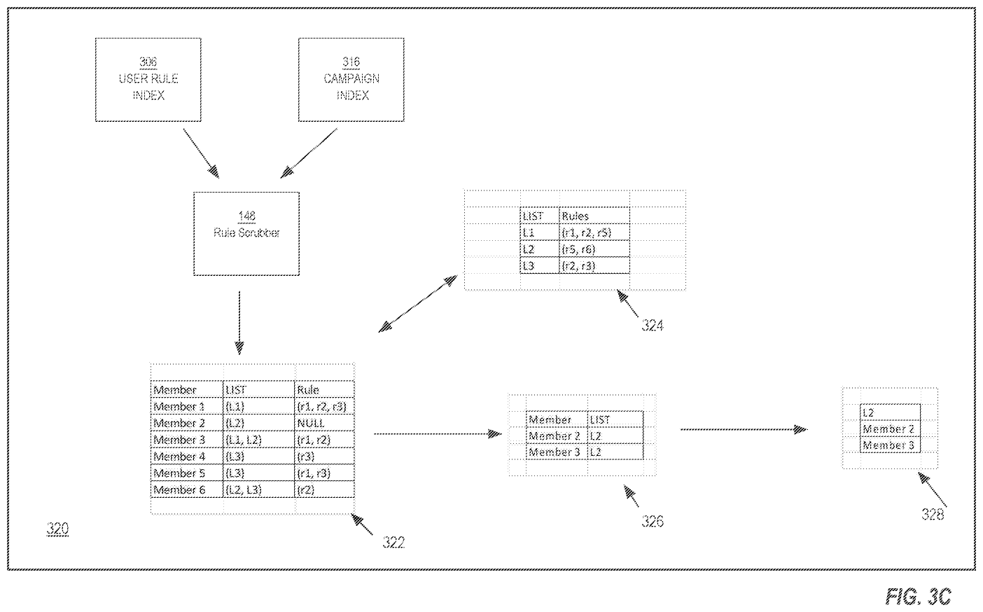

At block 274, for each user rule of the multiple user rules, a first set of users is identified. FIG. 3A is an example block diagram that depicts an example rule stitching process 300 performed by rule stitcher 144, in an embodiment. As shown in materialized rules 302 of FIG. 3A, zero or more members may be associated with each rule. Each rule may be organized based on a rule ID. In materialized rules 302, rule 1 is associated with member 1, member 3, member 5. Rule 2 is associated with member 1, member 3, and member 6. Rule 3 is associated with member 1, member 4, and member 5.

At block 276, a user rule index 306 is generated based on the set of users identified for each rule of the multiple user rules. The user rule index 306 may be generated to reorganize the rules to represent the relationship between each member and the associated rules. In other words, the user rule index matches the members to which rules the members are associated with. As shown in FIG. 3A, the user rule index 306 is organized based on member IDs. Consequently, it is clear from user rule index 306 that member 1 is associated with rule 1, rule 2, and rule 3, and member 3 is associated with rule 1 and rule 2. Member 2 is not associated with any of the rules.

Each entry in user rule index 306 may be represented in a single bitmap. Each entry in the bitmap corresponds to a different rule of a plurality of rules and indicates whether the different rule is applicable to the corresponding user. A bitmap can be converted into hexadecimal and prepared for bitmap manipulation operations.

At block 278, data about multiple campaigns is stored in campaign database 134. The campaigns are generated by a content provider and may include targeting criteria. A single content provider may provide multiple (e.g., all) campaigns indicated in campaign database 134. Campaign database 134 stores priority information for each campaign. Each campaign may be associated with a priority value that determines the level of priority. If a particular member is involved in a higher priority campaign, then the particular member is not considered for lower priority campaigns.

At block 280, for each campaign of the multiple campaigns, a second set of users is identified. FIG. 3B is an example block diagram that depicts an example campaign stitching process 310 performed by campaign stitcher 146, in an embodiment. As shown in campaign-member assignment 312 of FIG. 3B, zero or more members may be associated with each campaign. The associated members are target members who may be receiving electronic communications associated with the corresponding campaign unless further scrubbing and/or filtering processes are performed on those members. In campaign-member assignment 312, campaign 1 (L1) is associated with member 1, member 3, and member 5. Campaign 2 (L2) is associated with member 2, member 3, and member 6. Campaign 3 (L3) is associated with member 4, member 5, and member 6.

At block 282, a campaign index 316 is generated based on the set of users identified for each campaign of the multiple campaigns. The campaign index 316 may be generated to represent the relationship between each member and the associated campaigns. As shown in FIG. 3B, the campaign index 316 is organized based on the member IDs. In the campaign index 316, member 1 is associated with campaign 1, member 2 is associated with campaign 2, and member 3 is associated with both campaign 1 and campaign 2.

At block 284, for each user of multiple users indicated in the campaign index 316, a first set of zero or more user rules that is associated with each user is identified. Identification of the user rules can be determined by using the user rule index 306. FIG. 3C is an example block diagram that depicts an example rule scrubbing process 320 performed by rule scrubber 148. As shown in the scrubbing process 320 depicted in FIG. 3C, the user rule index 306 and the campaign index 316 are combined to generate a combined map 322 that lists, for each member, a set of one or more campaigns and a set of zero or more rules. The combined map may be generated by rule scrubber 148. For example, the combined map 322 shows the rules that are associated with each member in column 3.

At block 286, for each user of the multiple users indicated in the campaign index 316, a set of one or more campaigns is identified. In the illustrated example combined map 322, the set of campaigns is illustrated in column 2. The campaign information can be retrieved from campaign index 316. Based on the campaign association information and rule association information, combined map 322 may be generated.

At block 288, a second set of campaign rules of a campaign in the set of one or more campaigns is identified. As shown in a campaign-rule list 324, the campaign-rule list 324 associates campaigns and rules. Each campaign may be associated with zero or more rules that can narrow down the target members to adhere to the policies set by the content provider or administrator 120.

In the illustrated example campaign-rule list 324, campaign 1 is associated with rule 1, rule 2, and rule 5; campaign 2 is associated with rule 5 and rule 6; and campaign 3 is associated with rule 2 and rule 3. These rules may be applied to the campaigns separately from the combined map that represents the association among the rules, campaigns, and the members.

At block 290, rule scrubber 148 determines whether at least one rule in the second set of campaign rules is in the first set of zero or more user rules. The list of rules identified for a particular campaign in campaign-rule list 324 is compared to the rules identified for each member who is associated with the particular campaign in combined map 322. Rule scrubber 148 may identify any overlapping or intersecting rules in the two indices. A campaign that is associated with an intersecting rule is excluded from being a candidate campaign for the corresponding member.

For example, since campaign 1 in campaign-rule list 324 is associated with rule 1, rule 2 and rule 5, any members that are associated with campaign 1 and any of rule 1, rule 2, or rule 5 are excluded from campaign 1. Therefore, member 1 who is associated with campaign 1 is excluded from campaign 1, because member 1 is associated with rule 1 and rule 2 (rules that are associated with campaign 1; though only one of the two rules is sufficient). Likewise, member 3 who is associated with campaign 1 and rule 1 and rule 2 is excluded from campaign 1 because of the existence of at least one intersecting rule (either rule 1 or rule 2).

In another example, member 6 is excluded from campaign 3 because member 6 is associated with the intersecting rule for campaign 3, which is r2. However, member 6 would be associated with campaign 2 because rule 2 (which is the only rule associated with member 6) is not associated with campaign 2.

In one embodiment, rule scrubber 148 determines a priority for each campaign with which a particular member is associated. For example, member 3 is associated with campaign 1 and campaign 2. Assuming that the priority of campaign 1 is higher than campaign 2, rule scrubber 148 performs a rule scrubbing process on campaign 1 first. However, since campaign 1 is excluded from being a candidate campaign for member 3 because of at least one intersecting rule (i.e., either rule 1 or rule 2), rule scrubber 148 classifies the campaign 1 as an excluded campaign and performs a scrubbing process on campaign 2 next. Thus, only after determining that a campaign with a first highest priority value is excluded as a target campaign, rule scrubber 148 performs a rule scrubbing process on a campaign with the second highest priority. Since campaign 2 is associated with rule 5 and rule 6 in campaign-rule list 324 and member 3 is not associated with any of rule 5 or rule 6 in combined map 322, campaign 2 is selected to be associated with member 3. In this case, only campaign 2 will remain to be associated with member 3.

If the highest priority campaign is not excluded, then rule scrubber 148 may not perform a rule scrubbing process on the next highest campaign. Thus, even if a member may still be associated with two or more campaigns after the rule scrubbing process, the member may be associated with only the highest priority campaign. In other embodiments, a member may be associated with multiple campaigns at once indicating, for example, that the member may receive multiple electronic communications, one for each of multiple target campaigns for the member.

In some embodiments, each rule indication in the campaign-rule list 324 may be represented as a bitmap. Each entry in a bitmap for a campaign corresponds to a different rule of a plurality of rules and indicates whether the corresponding rule is applicable to the campaign. Based on a first rule bitmap for a member and a second rule bitmap for a campaign, rule scrubber 148 may perform one or more bitmap operations.

Because each member is associated with different rules and campaigns, computation/processing needs to be performed for each member. Thus, even though some members share a list of campaigns or a list of rules, the output list of the campaigns might not be the same for those members who share common campaigns or rules. Accordingly, computation engine 140 needs to perform the computation for each member and the computation processes including the rule stitching, list stitching, and rule scrubbing may be done in parallel.

After the rule scrubbing process, member 2 and member 3 are determined to be associated with campaign 2 as shown in member-campaign listing 326 in FIG. 3C. {member ID, campaign ID} pairs may be organized as an output table. In the illustrated example, pairs {member 2, L2} and {member 3, L2} are listed.

The output table can be rearranged to be listed based on a campaign ID and transposed back to individual campaign such as {campaign ID, member ID}. As shown in the illustrated example 328, pairs {L2, member 2} and {L2, member 3} may be generated. For purposes of illustrating a clear example, FIG. 3C only shows an output table for campaign 2. However, in other embodiments, other output tables for different campaigns may be generated.

Based on the output table 328 for campaign 2, communication generator 150 generates and causes to be sent, to member 2 and member 3, electronic communications based on campaign 2.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

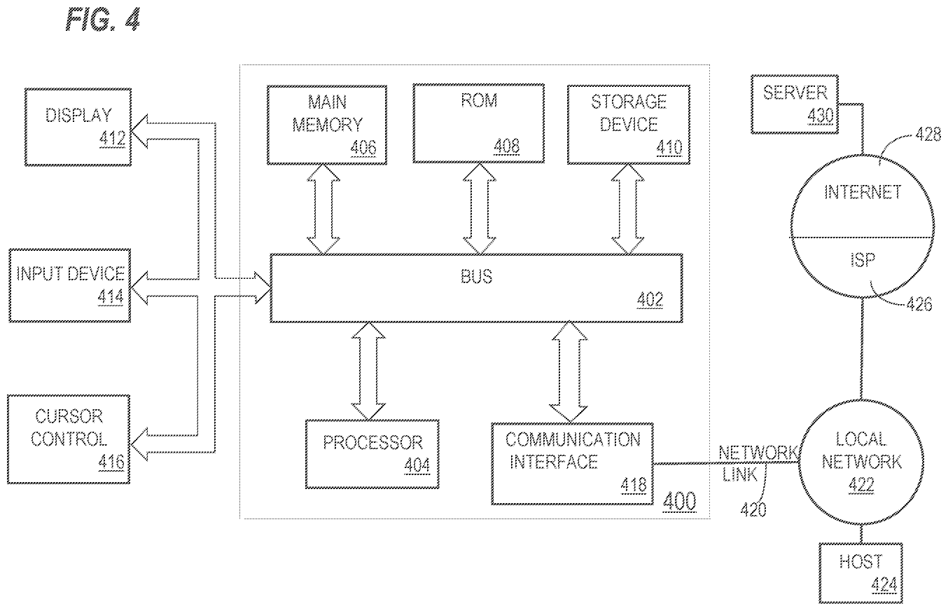

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

A cache is included as part of the main memory 406/storage components. The cache may be implemented using any conventional, sufficiently fast technology, such as by using one or more flash memory devices, random access memory, a portion of main memory, etc. The cache may be implemented as a Solid-State Disk (SSD) or a as a module on the server. Cache memory is read and written to store the HTML content generated at URL inference service 140.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a plurality of user rules;
for each user rule of the plurality of user rules, identifying a first set of users;
generating a user rule index based on the first set of users identified for each user rule of the plurality of user rules;
storing a plurality of campaigns;
for each campaign of the plurality of campaigns, identifying a second set of users;
generating a campaign index based on the second set of users identified for each campaign of the plurality of campaigns;
for each user of a plurality of users indicated in the campaign index:
identifying a first set of zero or more user rules, indicated in the user rule index, that are associated with said each user;
identifying a set of one or more campaigns for said each user;
identifying a second set of campaign rules of a campaign in the set of one or more campaigns;
determining whether at least one rule in the second set of campaign rules is in the first set of zero or more user rules;
wherein the method is performed by one or more computing devices.

2. The method of claim 1, further comprising:
in response to determining that at least one rule in the second set of rules is in the first set of zero or more rules for said each user, excluding said each user from the campaign.

3. The method of claim 2, further comprising:
if it is determined that at least one rule in a particular set of rules is also listed in the first set of zero or more user rules, then excluding said each user from being targeted by a particular campaign;
if it is determined that all rules in the particular set of rules are not listed in the first set of zero or more user rules, then including said each user as a targeted user of the particular campaign.

4. The method of claim 1, wherein a particular user of the plurality of users is associated, in the campaign index, with a plurality of campaigns that includes a first campaign and a second campaign, wherein the first campaign is associated with a higher priority than the second campaign, the method further comprising, for the particular user:
identifying a third set of rules, indicated in the rule index, that is associated with the particular user;
identifying a fourth set of rules associated with the first campaign;
determining whether any rule in the fourth set of rules is in the third set of rules;
only after determining that at least one rule in the fourth set of rules is in the third set of rules, determining whether any rule in a fifth set of rules associated with the second campaign is in the third set of rules.

5. The method of claim 1, wherein a particular user of the plurality of users is associated, in the campaign index, with a plurality of campaigns that includes a first campaign and a second campaign, wherein the first campaign is associated with a higher priority than the second campaign, the method further comprising, for the particular user:
identifying a third set of rules, indicated in the rule index, that is associated with the particular user;
identifying a fourth set of rules associated with the first campaign;
determining whether any rule in the fourth set of rules is in the third set of rules;
in response to determining that a rule in the fourth set of rules is not in the third set of rules, excluding the second campaign from consideration for the particular user.

6. The method of claim 1, wherein the set of zero or more rules of said each user of the plurality of users is indicated in a first bitmap, wherein each entry in the first bitmap corresponds to a different rule of the plurality of rules and indicates whether the different rule is applicable to said each user.

7. The method of claim 1, wherein the set of zero or more rules of said each campaign of the plurality of campaigns is indicated in a second bitmap, wherein each entry in the second bitmap corresponds to a different rule of the plurality of rules and indicates whether the different rule is applicable to said each campaign.

8. The method of claim 5, further comprising:
for a particular user of the plurality of users, identifying a particular campaign that is listed for the particular user;
identifying the first bitmap of rules for the particular user;
identifying the second bitmap of rules for the particular campaign;
performing one or more bitmap operations based on the first bitmap and the second bitmap.

9. The method of claim 1, further comprising:
upon determining that the at least one rule in the second set of campaign rules is not in the first set of zero or more user rules, sending an email associated with a particular campaign to said each user targeted by the particular campaign.

10. The method of claim 1, further comprising:
determining that a particular campaign is associated with a particular category;
storing category association data that associates each rule in a subset of the plurality of rules with one or more categories of a plurality of categories;
based on the category association data, determining a particular set of rules that are associated with the particular category;
associating the particular set of rules with the particular campaign.

11. One or more non-transitory computer-readable storage media storing instructions which, when executed by one or more processors, perform a method comprising:
storing a plurality of user rules;
for each user rule of the plurality of user rules, identifying a first set of users;
generating a user rule index based on the first set of users identified for each user rule of the plurality of user rules;
storing a plurality of campaigns;
for each campaign of the plurality of campaigns, identifying a second set of users;
generating a campaign index based on the second set of users identified for each campaign of the plurality of campaigns;
for each user of a plurality of users indicated in the campaign index:
identifying a first set of zero or more user rules, indicated in the user rule index, that are associated with said each user;
identifying a set of one or more campaigns for said each user;
identifying a second set of campaign rules of a campaign in the set of one or more campaigns;
determining whether at least one rule in the second set of campaign rules is in the first set of zero or more user rules.

12. The one or more non-transitory computer-readable storage media of claim 11, when executed, the method further comprising:
in response to determining that at least one rule in the second set of rules is in the first set of zero or more rules for said each user, excluding said each user from the campaign.

13. The one or more non-transitory computer-readable storage media of claim 12, when executed, the method further comprising:
if it is determined that at least one rule in a particular set of rules is also listed in the first set of zero or more user rules, then excluding said each user from being targeted by a particular campaign;
if it is determined that all rules in the particular set of rules are not listed in the first set of zero or more user rules, then including said each user as a targeted user of the particular campaign.

14. The one or more non-transitory computer-readable storage media of claim 11, wherein a particular user of the plurality of users is associated, in the campaign index, with a plurality of campaigns that includes a first campaign and a second campaign, wherein the first campaign is associated with a higher priority than the second campaign, the method further comprising, for the particular user:
identifying a third set of rules, indicated in the rule index, that is associated with the particular user;
identifying a fourth set of rules associated with the first campaign;
determining whether any rule in the fourth set of rules is in the third set of rules;
only after determining that at least one rule in the fourth set of rules is in the third set of rules, determining whether any rule in a fifth set of rules associated with the second campaign is in the third set of rules.

15. The one or more non-transitory computer-readable storage media of claim 11, wherein a particular user of the plurality of users is associated, in the campaign index, with a plurality of campaigns that includes a first campaign and a second campaign, wherein the first campaign is associated with a higher priority than the second campaign, the method further comprising, for the particular user:
identifying a third set of rules, indicated in the rule index, that is associated with the particular user;
identifying a fourth set of rules associated with the first campaign;
determining whether any rule in the fourth set of rules is in the third set of rules;
in response to determining that a rule in the fourth set of rules is not in the third set of rules, excluding the second campaign from consideration for the particular user.

16. The one or more non-transitory computer-readable storage media of claim 11, wherein the set of zero or more rules of said each user of the plurality of users is indicated in a first bitmap, wherein each entry in the first bitmap corresponds to a different rule of the plurality of rules and indicates whether the different rule is applicable to said each user.

17. The one or more non-transitory computer-readable storage media of claim 11, wherein the set of zero or more rules of said each campaign of the plurality of campaigns is indicated in a second bitmap, wherein each entry in the second bitmap corresponds to a different rule of the plurality of rules and indicates whether the different rule is applicable to said each campaign.

18. The one or more non-transitory computer-readable storage media of claim 15, when executed, the method further comprising:
for a particular user of the plurality of users, identifying a particular campaign that is listed for the particular user;
identifying the first bitmap of rules for the particular user;
identifying the second bitmap of rules for the particular campaign;
performing one or more bitmap operations based on the first bitmap and the second bitmap.

19. The one or more non-transitory computer-readable storage media of claim 11, when executed, the method further comprising:
upon determining that the at least one rule in the second set of campaign rules is not in the first set of zero or more user rules, sending an email associated with a particular campaign to said each user targeted by the particular campaign.

20. The one or more non-transitory computer-readable storage media of claim 11, when executed, the method further comprising:
determining that a particular campaign is associated with a particular category;
storing category association data that associates each rule in a subset of the plurality of rules with one or more categories of a plurality of categories;
based on the category association data, determining a particular set of rules that are associated with the particular category;
associating the particular set of rules with the particular campaign.
